(19) United States
(12) Patent Application Publication
(10) Pub. No.: US 2022/0042341 A1
(43) Pub. Date: Feb. 10, 2022

(54) Memorial Marker and Statuary Protector

(71) Applicant: Audist Pancake, Sisterville, WV (US)

(72) Inventor: Audist Pancake, Sisterville, WV (US)

(21) Appl. No.: 17/210,684

(22) Filed: Mar. 24, 2021

Related U.S. Application Data
(60) Provisional application No. 63/063,462, filed on Aug. 10, 2020.

(51) Int. Cl. E04H 13/00; E04H 15/44; E04H 15/64; G09F 23/00

(52) U.S. Cl. CPC E04H 13/001; E04H 13/003; G09F 23/00; E04H 15/64; E04H 15/44

(57) ABSTRACT

The present invention relates generally to a repositionable cover for a headstone, memorial marker or statuary. The cover shields the headstone, memorial marker or statuary from the weather, debris, pollution and vandalism. The covering may be entirely or partially transparent, or may be opaque with a transparent viewing window that allows a user to open the window to access the surface of the headstone, memorial marker or statuary.

### CROSS-REFERENCE TO RELATED APPLICATION

The present application claims priority to and the benefit of U.S. Provisional Application No. 63/063,462 filed on Aug. 10, 2020, which is incorporated herein by reference in its entirety.

### FIELD OF THE INVENTION

The present invention relates generally to a protective cover for a headstone, tombstone, memorial marker, statuary or gravestone cover. More specifically, the invention relates to a cover that is to be placed over the top of a headstone, tombstone, memorial marker, statuary or gravestone to protect the same from the elements (e.g., rain, snow, sleet, wind, etc.), debris, vandalism, etc. Nonetheless, the protective cover device may also be placed over other statuary or historical markers as well, such as those found in parks, yards or along roadsides. In differing embodiments of the device, the front surface of the covering may be transparent, or may have a transparent viewing window that allows a user to open the window to access the underlying headstone or marker. Additionally, any surface of the protective covering may further comprise an indica such as, but not limited to a lyric, poem, text, image, photo, bibliographic, historical or geographic information or any combination thereof. Accordingly, the present specification makes specific reference thereto. However, it is to be appreciated that aspects of the present invention are also equally amenable to other like applications, devices and methods of manufacture.

### BACKGROUND OF THE INVENTION

By way of background, gravestones, headstones, statuary and other memorial monuments and markers are constantly exposed to a plurality of environmental weather factors by virtue of existing outdoors and in the open air. For example, it is not uncommon for these objects to become weathered from a multitude of conditions including snow, rain, sleet, hail, wind, freezing, excessive heat, pollution, etc., and exposure to the same may tarnish, wear away and/or erode the face and body of the headstone or marker.

Furthermore, other environmental and natural occurrences, such as bird droppings, tree sap, air particulates, dirt, dust, pollution and acid rain, can also tarnish and obscure the face and body of the headstone or marker over time. Still other markers and stones may be subject to vandalism or other intentional and destructive acts. The exposure of the headstone to such elements, occurrences and intentional acts may ultimately render any inscription or other writing on the headstone or marker illegible, which is obviously undesirable for living family members of the decedent, as well as others in a park, yard or along a roadside from reading information contained on the stone or marker.

In an effort to prevent the deterioration of the headstone or marker, family members may take steps to routinely maintain and clean the headstone or marker. Such cleaning may often involve regular power washing or intense scrubbing to remove debris, pollution buildup and the like from the surface of the headstone or marker, which may be increasingly difficult the longer the debris and particulates have been present on the surface of the marker or stone. Family members, volunteers, homeowners, etc. may also employ specific chemical cleaners to clean the surface, which can be costly and impractical. Further, the overall burden of regularly cleaning and maintaining a headstone or marker may not be possible based on the time-constraints imposed by the jobs, careers, hobbies, etc. of the decedent's family members, their proximity to the headstone or marker and the overall cost of regular maintenance. Additionally, the activities of power washing, using chemicals, brushing and the like can also speed up the deterioration of the marker or stone.

Furthermore, many individuals desire to adorn a loved one's headstone with a plurality of quotes, lyrics, images, etc., but may be restricted in doing so based on the cost of engraving the headstone or marker or the engraving abilities of the headstone or marker supplier. Additionally, the inclusion of such indica may be physically limited by the total available surface area of the headstone or marker itself. Also, the types and color of the indica that can adorn a headstone are oftentimes limited to being engraved in the color of the headstone material.

Therefore, there exists a long felt need in the art for an improved headstone, memorial marker, or statuary protector device. There is also a long felt need in the art for an improved headstone memorial marker, or statuary protector device that protects a headstone or marker such that the surface of the headstone, memorial marker, or statuary cannot become soiled with various debris, particles, or pollutants, etc., as well as to help protect the marker or statuary from vandalism and graffiti. Moreover, there is a long felt need in the art for a headstone, memorial marker, or statuary protector device that allows a user to further display additional indica that may include, but is not limited to, lyrics, poems, words, images, characters, etc. in lieu of or in conjunction with any similar indica on the headstone, memorial marker, or statuary itself, and for a protective cover that allows the indicia to be changed over time without modifying the headstone itself. Finally, there is a long felt need in the art for a headstone, memorial marker, or statuary protector device that is relatively inexpensive to manufacture, repositionable as desired by the user and that is both safe and easy to transport and use.

The present invention, in one exemplary embodiment, discloses a protective cover device for a headstone, memorial marker, statuary, etc. The protective cover device is preferably comprised of a geometrically-shaped frame and a protective cover supported by said frame. The shaped frame is comprised of a plurality of interconnected tubular frame members manufactured from plastic, PVC or other suitable materials. The protective cover is preferably a washable and weather-resistant canvas cover that is draped over the frame to sufficiently enclose and cover the headstone or marker to protect it from inclement weather, debris, pollution or other contaminants. The protective cover may be secured to both the frame and the ground below the frame via a plurality of tethered hooks, spikes, weights, or combinations thereof. The protective cover may further comprise a transparent front surface or viewing window that allows the front surface of the headstone or marker itself to be viewed and/or accessed. Nonetheless, the protective cover of the present invention is not so limited, and any other suitable material could comprise the window or transparent opening. Similarly, the front surface or other surfaces of the protective cover may further comprise indica, such as quotes, lyrics, images, messages, etc. in color, and that may be changed by the user from time to time to honor a deceased loved one and without revising the tombstone itself, which can be very expensive. Finally, the side surfaces of the protective cover may further include a plurality of vents or ventilation means to prevent condensation build up within the protective cover, which could damage the marker over time.

In this manner, the improved headstone, memorial marker, or statuary protector device of the present invention accomplishes all of the forgoing objectives, thereby allowing a user to adequately protect and cover a headstone, memorial marker, statuary, etc. from inclement weather, debris, pollution, and particulates that may erode and soil the headstone, memorial marker, or statuary over time. The protective cover device also allows a user to add and display a plurality of additional indica, such as quotes, messages, lyrics, images, etc., in and around the headstone, memorial marker, or statuary both in color and with the ability to freely change the same.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some concepts in a simplified form as a prelude to the more detailed description that is presented later.

The subject matter disclosed and claimed herein, in one embodiment thereof, comprises a headstone, memorial marker or statuary protective cover device. In a preferred embodiment, the protective cover is comprised of a shaped frame that can be sized and configured to fit over a headstone, marker or statuary piece, and that can be placed over top and around a headstone, memorial marker or statuary surface such that the headstone, memorial marker, or statuary sits within an interior of the frame. The frame itself is comprised of a plurality of tubular plastic or PVC frame members that are connected to one another by a plurality of angled joint connectors to form the frame. The frame may further comprise a plurality of feet or supports that allow the frame to rest slightly above the ground surface, but to still be securely anchored thereto.

The protective cover device is further comprised of a protective cover or canvas that is placed over and supported by the frame. The protective cover is preferably constructed from a washable and weather-resistant canvas material that has two opaque side surfaces, an opaque rear surface, and a transparent front surface. Nonetheless, in alternate embodiments, the protective cover may have any number of transparent sides, or may have only a single transparent front viewing window that can be opened to provide the user with access to the headstone, memorial marker or statuary. Additionally, the canvas material may be comprised of a relatively rigid, transparent or opaque material, such as plastic, and may further comprise a plurality of eyelets positioned around the base of the cover in spaced apart fashion to receive tethers or anchors that allow the protective cover to be secured to and around the bottom portion of the tubular frame on each side of the device. Further, at least one end of the hooked tether may comprise one or more spikes that can be inserted into the ground to further anchor the protective cover device thereto. Alternatively, the protective cover device may comprise one or more weights to secure the protective cover in a proper and desired position.

The front surface of the protective cover can also have a plurality of indica including, but not limited to, words, images, lyrics, quotes, symbols, charts and/or photographs in full color or no color. The side surfaces and rear surfaces of the cover may also have the same or similar indica, and it is further contemplated that all surfaces of the protective cover may have one or more vents that allow for air movement and prevent condensation from forming on the inside of the protective cover.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of one potential embodiment of a protector device of the present invention in accordance with the disclosed architecture, wherein the protective device is covering a headstone;

FIG. 2 illustrates a perspective view of one potential embodiment of a protector device of the present invention in accordance with the disclosed architecture, wherein the front surface of the protective device is in an open position;

FIG. 3 illustrates a rear perspective view of one potential embodiment of a protector device of the present invention in accordance with the disclosed architecture;

FIG. 4 illustrates a perspective view of one potential embodiment of a joint connection of the protector device of the present invention in accordance with the disclosed architecture; and

FIG. 5 illustrates a perspective view of one potential embodiment of an eyelet and securing hook or tether of the protector device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As noted above, there exists in the art a long felt need for an improved headstone, memorial marker or statuary protector device. More specifically, there is a long felt need in the art for an improved headstone, memorial marker or statuary protector device that protects a headstone or marker from various debris, particles, pollutants, vandalism etc. which may over time soil, damage or erode the surface of the headstone or marker. There is also a long felt need in the art for a headstone, memorial marker or statuary protector device that allows a user to display indica that may include, but is not limited to lyrics, poems, words, images, characters, etc., in lieu of or in conjunction with any similar indica on the headstone or marker itself.

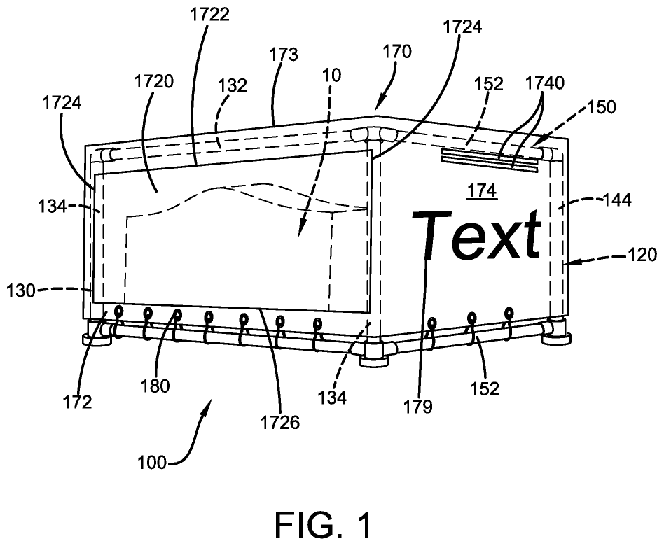

Referring initially to the drawings, FIG. 1 illustrates a perspective view of one potential embodiment of a protector cover device 100 of the present invention in accordance with the disclosed architecture, wherein the protective cover device 100 is covering a headstone 10. More specifically, the protective device 100 is comprised of a frame 120 and a protective cover 170 that is supported by the frame 120. The frame 120 is preferably geometrically shaped, such as rectangular or square, though other geometric and non-geometric shapes can also be used. Nonetheless, the frame 120 is preferably shaped and configured to be placed over top of and to substantially enclose a headstone or marker 10.

The frame 120 provides structural support to the device 100, and acts to support, and serve as an attachment point for, the body cover 170. The frame 120 is comprised a plurality of tubular frame members, preferably made of plastic or PVC, that can be secured together to form a generally square or rectangular front frame 130, a generally square or rectangular rear frame 140 and two generally square or rectangular side frames 150. Nonetheless, in alternative embodiments of the protective cover device 100, the various elements of the frame 120 may be manufactured from other suitable materials, such as stainless steel, aluminum, wood, cast-iron, etc., and may be tubular or non-tubular in shape.

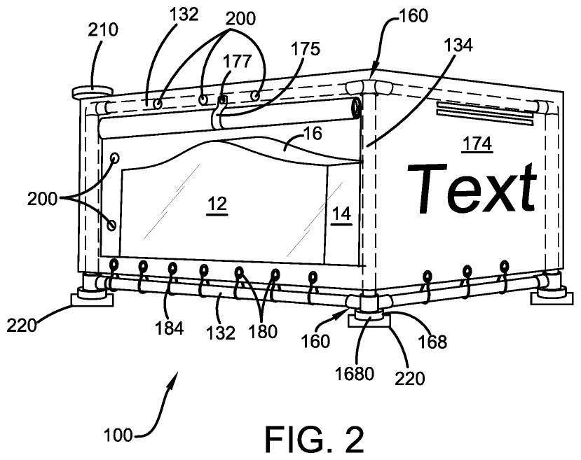

As best shown in FIGS. 1-3, each of the front, rear and side frames 130, 140, 150 are generally rectangular in shape in the preferred embodiment, as most tombstones, headstones and memorials are generally rectangular in shape. More specifically, the front frame 130 is comprised of two generally parallel and spaced apart horizontal frame members 132 and two generally parallel and spaced apart vertical frame members 134, wherein each of the vertical frame members 134 are positioned at a respective end of each of the two generally parallel and spaced apart horizontal frame members 132. Similarly, the rear frame 140 is comprised of two generally parallel and spaced apart horizontal frame members 142 and two generally parallel and spaced apart vertical frame members 144, wherein each of the vertical frame members 144 are positioned at a respective end of each of the two generally parallel and spaced apart horizontal frame members 142. Further, when frame 120 is fully constructed, the front frame 130 and rear frame are generally parallel to one another in a spaced apart fashion and attached to each other via the plurality of horizontal side frame members 152, as best shown in FIGS. 1 and 2.

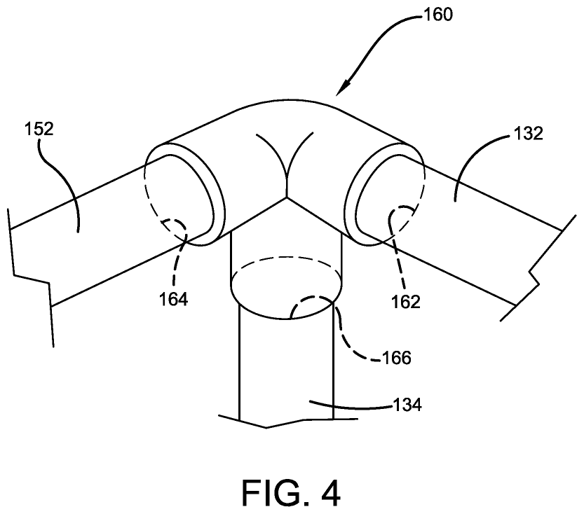

Further each of the front frame 130, the rear frame 140 and both side frames 150 are connected to one another by a joint connector piece 160, as best shown in FIG. 4. In the preferred embodiment, each connecter piece 160 has three continuous openings 162, 164, 166 therein for receipt of a respective frame member of one of the front, rear or side frames 130, 140, 150, respectively. More specifically, each connector piece 160 is preferably positioned at the bottom and top corners of each of front frame 130 and rear frame 140, such that the first opening 162 receives a horizontal frame member 132, 142 of the front or rear frames 130, 140, respectively.

The second opening 164 further receives the horizontal frame member 152 of one side of the frame 150, and the third opening 166 receives the respective vertical frame member 134, 144 of the front or rear frames 130, 140. Accordingly, it is contemplated that one protective cover device 100 will be comprised of at least eight connectors 160, one positioned at each of the corner junctions of the various frames 130, 140, 150 to allow the frame 120 to form a generally square or rectangular shape.

In the preferred embodiment of the protective cover device 100, each subframe member 132, 134, 142, 144, 152 is preferably removably secured within the connector 160 via a friction or constriction fit, such that each member 132, 134, 142, 144, 152 fits inside a select one of the openings 162, 164, 166 of the connector 160. Nonetheless, in differing embodiments of the protective cover device 100, each of the ends of the various frame members 132, 134, 142, 144, 152 may further be secured into the openings 162, 164, 166 by other means such as, but not limited to, a groove/channel means or a fastening means, such as a bolt-on connection, screws, pins, etc. Alternatively, each of connectors 160 may be fixedly attached or integrally formed with one or more subframe members 132, 134, 142, 144, 152.

As previously stated, the protective cover device 100 is further comprised of a cover 170 that rests upon, or can be draped over top of, the frame 120 to ultimately protect the headstone, memorial marker, or statuary 10 from weather elements, pollution, vandalism and other debris that may soil, deface or erode the headstone or marker. In the preferred embodiment of the protective device 100, the cover 170 is comprised of a washable and weather-resistant canvas material that may also be waterproof or coated in a waterproof coating or membrane. In alternative embodiments, the cover 170 may be comprised of a nylon, polyester, PVC-backed fabric, etc.

The cover 170 is further comprised of a front surface 172, two side surfaces 174, a rear surface 176 and a top surface 173. A round configuration may also be created, for example, to cover a statute, obelisk or other similar shape. In a preferred embodiment of the device 100, each of the top surface 173, side surfaces 174 and rear surface 176 is opaque, and the front surface 172 is either transparent or has a transparent viewing window 1720 to allow an individual to view and access the front surface 12 of the headstone, memorial marker or statuary 10 that is housed within and protected by the device 100. Nonetheless, in other embodiments, each of surfaces 172, 173, 174, 176 of the cover 170 may be transparent, semi-transparent or opaque. Further, all surfaces of the protective cover 170 may have a plurality of continuous openings in the form of vents or slits 1740 as shown in FIG. 1, which allows moisture to exit the protective device 100 to prevent condensation and mold or mildew from forming on the interior of the protective device 100 or on the monument 10.

Additionally, any portion of any of surfaces 172, 173, 174, 176 of the cover 170 may have an indica 178 such as, but not limited to, song lyrics, prayers, bible verses, words, images, photographs, paintings, symbols, graphics and combinations thereof in full or no color. This includes the front surface 172 even in an embodiment of the device 100 that has a front surface 172 and transparent viewing window 1720, wherein the indica may then be semi-transparent or opaque (as well as in full-color) and may be present on the front surface 172, viewing window 1720, or both. The indicia 178 may be printed on the outer surface or inner surface of the cover 170, or on both.

FIG. 2 illustrates a perspective view of one potential embodiment of a protector device 100 of the present invention in accordance with the disclosed architecture, wherein the front surface of the protective device 100 is in an open position. In the preferred embodiment of the device 100, all of the surfaces or panels 172, 173, 174, 176 of the cover 170 are fixedly and inseparably attached to one another in one continuous cover 170 body. However, in an alternative embodiment of the device 100 as seen in FIG. 2, front surface 172, which has a transparent viewing window 1720, is able to be rolled up and secured to allow a user to access the headstone 10. In this embodiment of the device 100, it is contemplated that the window 1720 may be comprised of a plurality of snap-button fastening means (not shown) on the rear surface of the window 1720 along the bottom 1726 and side edges 1724, wherein the buttons engage a plurality of snap-button fastening means (also not shown) on the portion of the front surface 172 that remains in place permanently whenever the window 1720 is rolled up into an open position.

Nonetheless, in differing embodiments of the device 100, the snap-buttoning means may be positioned on any of surfaces 172, 173, 174, 176 of the cover 170 or may be comprised of any other fastening means such as, but not limited to, a hook and loop fastening means, a zipper fastening means, a magnetic fastening means, etc. Further, the top edge 1722 of the window 1720 would be fixedly attached and inseparable from the front surface 172 to act to retain the window 1720 to the front surface 172 when in a rolled position (e.g. as an anchor point). Once the snap-button means are fastened, the viewing window 1720 is secured in place to the front surface 172, but when unfastened, all or a portion of the viewing window 1720 can be rolled upwards into a cylindrical roll and be secured to the front surface 172 via a securing strap 176 that also comprises the window 1720. The securing strap 175 may have a snap-button means 177 that engages a snap-button means (not shown) near the top of the front surface 172.

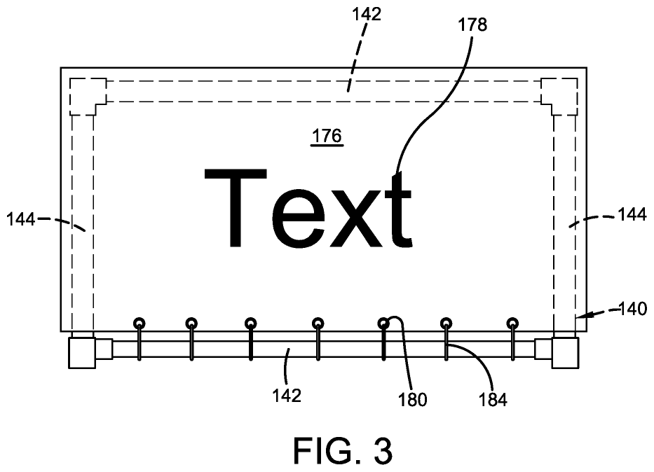

An embodiment of the device 100 with indica 178 on the rear surface 176 can further be observed in FIG. 3. Further, any of surfaces 172, 173, 174, 176 of the cover 170 may also have a plurality of battery-powered LED lights 200 (see e.g., FIG. 2) as part of the graphics that may illuminate the cover 170 and/or the indica 178. The LED lights 200 may also be positioned in the tubular frame, around the periphery of the cover 170 or on the walls of the cover 170. The LED lights 200 may also be solar-powered 210, and activated only when a sufficient level of darkness has been detected. Weights 220 may also be provided on the supports or feet of the frame 120, as also shown in FIG. 2.

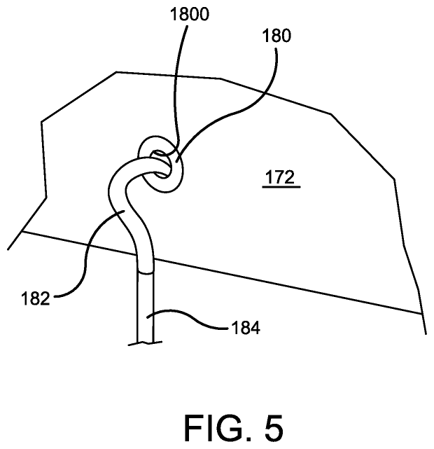

FIG. 5 illustrates a perspective view of one potential embodiment of an eyelet and securing hook or tether of the protector device 100 of the present invention in accordance with the disclosed architecture. More specifically, the cover 170 may be secured to the frame 120 of the device 100 via a plurality of eyelets 180 that are positioned along each of surfaces 172, 174, 176 of the cover 170, with the exception of the top surface 173. Each of the eyelets 180 are preferably arranged in a row-like fashion along or near the bottom edge of each of surfaces 172, 173, 174, 176, and have a continuous opening 1800 therein that can receive a stainless hook 182 that is attached to a tether 184 as best observed in FIG. 5. The hook 182 is preferably fixedly and inseparably attached to the tether 184, wherein the tether 184 is comprised of an elastic band-like material. The tether 184 is preferably fixedly attached to the bottom horizontal frame members 132, 142, 152 of each of frames 130, 140, 150, respectively. However, in an alternative embodiment, the tether 184 may be removably attached via a plurality of continuous openings (not shown) in each horizontal frame member 132, 142, 152 which are engaged via a second hook (not shown) that is positioned on the other end of the tether 184.

Additionally, in one embodiment, the tether 184 may be hooked through each eyelet 180, wrapped around each frame member 132, 142, 152 and then secured through the back of each eyelet 180. In still other embodiments, the protective device 100 may be comprised of surfaces or panels 172, 174, 176 that are fixedly attached to each of frames 130, 140, 150 and cannot be removed. The fixed attachment means may include, but is not limited to, rivets, screws, bolts, adhesive glue, etc. Further, in another embodiment, the protective device 100 may have a hook surface along each of the frames 130, 140, 150 for engaging a loop surface positioned along the inner surfaces of the cover 170 to allow the cover 170 to be removably attached to the frame 120.

In one embodiment, the frame 120 may further comprise a plurality of feet or supports 168 that may be attached to those connectors 160 that are positioned near the bottom of the device 100 (i.e., nearest the ground). Each of the feet 168 are preferably flat, plate-like members, that may be constructed from the same material as the connector 160 or from a differing material. The feet or supports 168 may also be provided with weights 220, as best shown in FIG. 2, and may be removably or fixedly attached to the connector 160. The feet 168 may also have a textured bottom surface 1680 that may include a plurality of textured spikes that aid in retaining the feet or supports 168 into the ground (e.g. after a user places the device 100 over a headstone, memorial marker, or statuary 10 and then steps on the feet 168) to anchor the device 100 into the ground. Further, each foot 168 may be comprised of a continuous opening that allows a user to place a ground spike through the opening to further anchor the feet 168 to the ground.

Notwithstanding the forgoing, the memorial protection device 100 of the present invention can be of any suitable size, shape, and configuration as is known in the art without affecting the overall concept of the invention, provided that it accomplishes the above stated objectives. One of ordinary skill in the art will appreciate that the shape and size of the memorial protection device 100 and its various components as shown in the FIGS. are for illustrative purposes only, and that many other shapes and sizes of the memorial protection device 100 are well within the scope of the present disclosure. Although the dimensions of the memorial protection device 100 and its various components (i.e., length, width, and height) are important design parameters for good performance, the memorial protection device 100 and its various components may be of any shape or size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A memorial marker protection device comprising:
a cover sized and configured to fit over a memorial marker, wherein the cover comprises a front wall, a back wall, a pair of side walls, a top wall, and an open bottom, and further wherein at least one of the front, back, side and top walls have a transparent portion.

2. The memorial marker protection device as recited in claim 1, wherein the cover is supported by a frame.

3. The memorial marker protection device as recited in claim 2, wherein the frame comprises a plurality of tubular elements positioned at intersections of the front, back, paid of side and top walls.

4. The memorial marker protection device as recited in claim 3, wherein the frame includes a plurality of frame connectors sized and configured to an end portion of each of the plurality of tubular elements to hold the frame in a shaped configuration.

5. The memorial marker protection device as recited in claim 4, wherein the shaped configuration is a geometric shape.

6. The memorial marker protection device as recited in claim 5, wherein the geometric shape is a square or a rectangle.

7. The memorial marker protection device as recited in claim 6, wherein at least one of the front, back, pair of side and top walls is opaque.

8. The memorial marker protection device as recited in claim 1, wherein at least one of the front, back, pair of side and top walls is provided with an indicia.

9. The memorial marker protection device as recited in claim 8, wherein the indicia comprises two or more of a lyric, a combination of words, an images, a photograph, a poem, a prayer, a symbol, a chart, a map, a graphic, and a combination thereof.

10. The memorial marker protection device as recited in claim 2, wherein the frame further comprises a support.

11. The memorial marker protection device as recited in claim 2, wherein the frame is constructed from one of a plastic, a PVC, a wood, a stainless steel, a cast iron, and an aluminum.

12. The memorial marker protection device as recited in claim 2, wherein the cover includes a roll up portion.

13. The memorial marker protection device as recited in claim 1, wherein the memorial marker is one of a headstone, a tombstone, a gravestone, a historical marker, a statute or a statuary.

14. A headstone cover comprising:
a frame having a plurality of tubular elements that form a shaped configuration; and
a cover disposed over the frame, wherein the cover is comprised of at least one opaque side and at least one transparent side, and further wherein the frame is further comprised of a plurality of supports attached to the frame.

15. The headstone cover as recited in claim 14, wherein at least one side of the cover is provided with an indicia.

16. The headstone cover as recited in claim 15, wherein the indicia includes at least one of a lyric, a word, an image, a photograph, a poem, a prayer, a symbol, a chart, a map, a graphic, and a combination thereof.

17. The headstone cover as recited in claim 14, wherein the frame is comprised of a plastic, a PVC, a wood, a stainless steel, a cast iron, or an aluminum.

18. The headstone cover as recited in claim 15, wherein the cover is a waterproof canvas material.

19. A combination memorial marker and cover comprising:
a memorial marker having a shape;
a cover having a form that is substantially similar to the shape of the memorial marker, wherein the cover is comprised of a top, a plurality of walls defining an interior for receipt of the memorial marker, and a rigid frame; and
an indicia that is applied to a portion of at least one of the plurality of walls, wherein the cover is further comprised of a viewing panel.

20. The combination memorial marker as recited in claim 19, wherein the memorial marker is selected from a group including a headstone, a tombstone, a gravestone, a historical marker, a statute or a statuary.
